(19) United States
(12) Patent Application Publication
(10) Pub. No.: US 2009/0242665 A1
(43) Pub. Date: Oct. 1, 2009

(54) MISTING SYSTEM WITH INJECTOR FOR INTRODUCING A COMPOSITION INTO FLUID

(75) Inventors: Gary F. Wintering, Chandler, AZ (US); Peter van de Graaff, Sevenum (NL)

Correspondence Address: MESCHKOW & GRESHAM, P.L.C., 5727 NORTH SEVENTH STREET, SUITE 409, PHOENIX, AZ, 85014, US

(73) Assignee: FOGCO SYSTEMS, INC., Chandler, AZ (US)

(21) Appl. No.: 12/056,581

(22) Filed: Mar. 27, 2008

(51) Int. Cl. B05B 7/26

(52) U.S. Cl. 239/310; 239/403

(57) ABSTRACT

An injector (22) for use with a misting system (20) includes a main body (30) and a converging-diverging nozzle (58) positioned within a channel (54) of the main body (30). A composition (50) is placed in a mixing chamber (38) integrally formed with the main body (30). A portion (86) of water (56) flowing through channel (54) of the main body (30) is diverted through a conduit (74) and into an upper end (82) of the mixing chamber (38). The water (56) turbulently mixes with the composition (50) to form a mixture (88) of the composition (50) and water (56). This mixture (88) is siphoned from a lower end (70) of the mixing chamber (38) through a fluid port (62) and into nozzle (58), where it is subsequently discharged from the injector (22).

### TECHNICAL FIELD OF THE INVENTION

The present invention relates to the field of misting systems. More specifically, the present invention relates to an injector in a misting system for introducing a composition into fluid to be discharged from the misting system.

### BACKGROUND OF THE INVENTION

An odor is a volatilized chemical compound, generally at a very low concentration, which humans and other animals perceive by the sense of olfaction. The terms fragrance, scent, or aroma are typically used to describe a pleasant odor, while the terms stench, reek, stink and the like are used specifically to describe an unpleasant odor.

The perception of odors and emotional responses linked with those odors is very much dependent upon circumstance and culture. Some believe that pleasant fragrances can boost relaxation and positively affect alertness, social interaction, sleep, stress, and general feelings of well-being. Furthermore, pleasant fragrances can be of sufficient strength to obscure other, less desirable odors.

Unpleasant odors can arise from certain industrial processes, adversely affecting workers and even residents downwind of the industry. The most common sources of industrial odor arise from sewage treatment plants, refineries, certain livestock facilities, and industries processing chemicals (such as sulfur) which have odorous characteristics.

Although industrial processes are a large source of unpleasant odors, some unpleasant odors may be generated in and around the home. For example, the odor of cooking processes may be pleasurable while cooking but may be considered unpleasant after the meal. Similarly, a group of people gathered on a hot outdoor patio may generate unpleasant odors. Thus, in many outdoor areas it is desirable to alter the smell or odor present in these outdoor areas.

Great energy and ingenuity has been applied to masking, eliminating, and preventing unpleasant odors in an environment using candles, incense, odor neutralizing or masking sprays, solids, and the like. Indeed, fragrances have been utilized for thousands of years to mask unpleasant odors. Moreover, interest in essential oils has revived in recent decades with the popularity of aromatherapy which claims that the specific aromas carried by essential oils can affect a person's mood or health.

Often prior art techniques do not effectively disburse compositions, such as fragrances, into an ambient environment. This problem is exacerbated outdoors where a breeze may blow out candles or blow away a sprayed fragrance or deoderizer. In addition, the manual application of a sprayed fragrance can be obtrusive during a social gathering, can result in pockets of excessive fragrance, and can use an undesirably large quantity of fragrance.

Thus, what is needed is a system for the effective disbursement of fragrance, essential oil, air freshener, deoderizer, insect repellant, insecticides, or any other approved chemical additive or agent for enhancing an environment.

### SUMMARY OF THE INVENTION

Accordingly, it is an advantage of the present invention that a system is provided for delivery of a composition into an environment.

It is another advantage of the present invention that a system is provided for introducing a composition at an appropriate concentration into a fluid for discharge through a misting device.

Another advantage of the present invention is that a system is provided that can be inexpensively manufactured and readily incorporated into an existing misting system.

Yet another advantage of the present invention is that a system is provided for delivery of a composition, such as a fragrance, essential oil, deoderizer, insect repellant, in a wide variety of environments.

The above and other advantages of the present invention are carried out in one form by a system for introducing a composition into a fluid. The system includes a main body having a body inlet, a body outlet, and a channel for carrying a flow of fluid from the body inlet to the body outlet. A converging-diverging nozzle is positioned within the channel. The nozzle includes a passage aligned with the channel and a fluid port extending through a side wall of the nozzle. The system further includes a mixing chamber for placement of the composition, the mixing chamber having a chamber outlet in fluid communication with the fluid port. A conduit has a conduit inlet through a side of the main body upstream from the converging-diverging nozzle and the conduit has a conduit outlet into the mixing chamber upstream from the chamber outlet. The conduit carries a portion of the fluid to the mixing chamber to mix with the composition.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows an illustration of a misting system incorporating in injector in accordance with an embodiment of the present invention;

FIG. 2 shows a side view of the injector;

FIG. 3 shows a side view of the internal structure of the injector;

FIG. 4 shows a side sectional view of the internal structure of the injector; and

FIG. 5 shows a top sectional view of a mixing chamber of the injector.

### DETAILED DESCRIPTION OF THE PREFERRED EMBODIMENTS

Misting systems have become popular for cooling, humidification, odor, and/or dust control. For example, the rapid evaporation of mist or moisture is capable of quickly and efficiently cooling outdoor areas, such as private and commercial patios, outdoor restaurants, livestock enclosures, and so forth. The present invention takes advantage of the prevalence of misting systems by incorporating an injector system into a misting system for the disbursement in a desired location of a composition at an appropriate concentration. The composition may be a fragrance, essential oil, air freshener, deoderizer, insect repellant, insecticide, or any other approved chemical additive or agent for enhancing an environment.

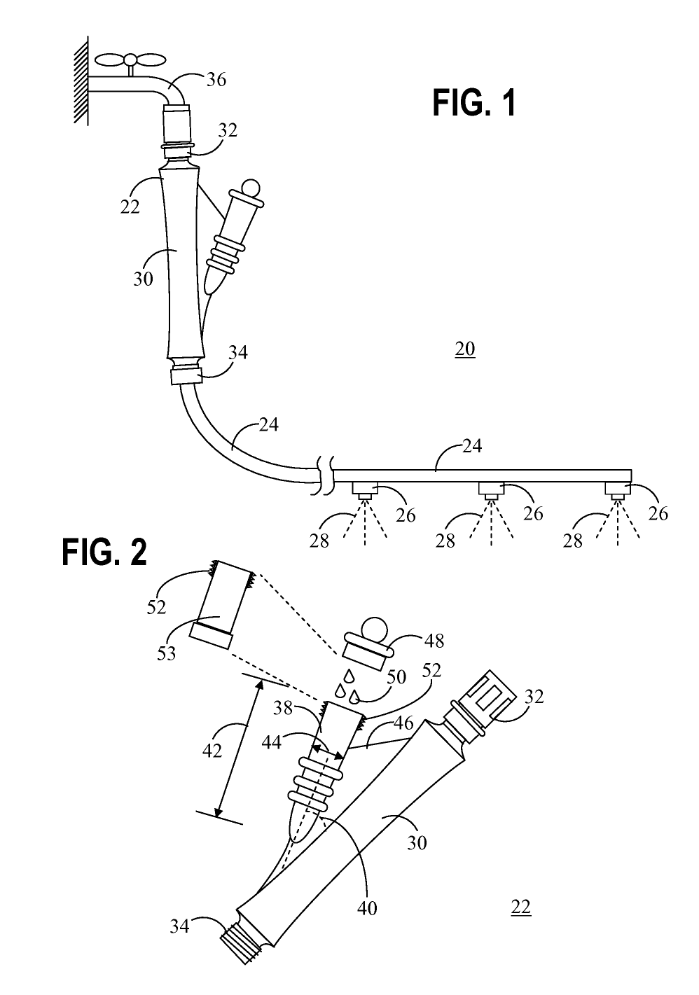

FIG. 1 shows an illustration of a misting system 20 incorporating in injector 22 in accordance with an embodiment of the present invention. Misting system 20 includes at least a delivery line 24 and a plurality of misting nozzles 26 in fluid communication with delivery line 24. Misting nozzles 26 are adapted to discharge a mist 28 of atomized droplets of water.

The term “fluid communication” refers to direct connection or indirect connection via components interposed between delivery line 24 and misting nozzles 26 that enable a flow of fluid, in this instance, water from delivery line 24 to misting nozzles 26. In one embodiment, misting nozzles 26 may be directly connected to delivery line 24. In another embodiment, a downstream end of delivery line 24 may connect to a filter, pump, manifold, and the like. Misting nozzles 26 may then connect to additional fluid carrying tubing connected to the output of the filter, pump, manifold, and so forth.

Injector 22 includes a main body 30 having a body inlet 32 and a body outlet 34. Body inlet 32 is adapted for connection to a fluid source 36. In this case, fluid source 36 is an outdoor water spigot, also referred to as a valve, a tap, hose bib, and the like. Body inlet 32 may include, for example, female threads that couple with the conventional male threads of an outdoor water spigot. Body outlet 34 of main body 30 is adapted for connection to delivery line 24. For example, body outlet 34 may include male threads that couple with corresponding female threads of delivery line 24.

FIG. 2 shows a side view of injector 22. In addition to main body 30, injector 22 further includes a mixing chamber 38. In one embodiment, mixing chamber 38 is arranged with main body 30 to form an acute angle 40 between a length 42 of mixing chamber 38 and main body 24. In addition, length 42 of mixing chamber 38 is greater than a width 44, or diameter of mixing chamber. Thus, chamber 38 has a generally elongated shape. However, the configuration of mixing chamber 38 described herein is not a limitation of the invention. For example, the orientation of mixing chamber 38 and/or the shape of mixing chamber 38 may differ from that which is shown and described herein. Injector 22 may be manufactured from a thermoplastic or thermosetting plastic material. Thus, mixing chamber 38 can readily be formed integrally with main body 30 using, for example, an injection molding technique, a rotational molding technique, and the like. A fin, or support region 46 may thus be formed between mixing chamber 38 and main body 30 for added strength and durability.

Mixing chamber 38 includes a cap 48 that is removable in order to place a composition 50 into mixing chamber 38. In one embodiment, cap 48 may be threaded so as to mate with corresponding threads 52 on mixing chamber 38. In alternate embodiments, other removable configurations for cap 48 may be envisioned, such as a plug, hinged cap, and the like.

In still other embodiments, a secondary container 53 may be interposed between mixing chamber 38 and cap 48. For example, secondary container 53 may be threaded to mate with corresponding threads 52 on mixing chamber 38. Likewise, secondary container 53 may include threads 52 to which cap 48 can couple. Composition 50 can than be loaded into an internal passage (not visible) of secondary container 53 that is in fluid communication with mixing chamber 38. The inclusion of secondary container 53 can significantly increase the volume of composition 50 which may be used with injector 22.

In one embodiment, composition 50 is an oil-based composition in liquid form. Such an oil-based composition is preferred because its specific gravity is typically less than that of water so that it will not readily mix with water and will tend to float on top of water. Alternatively, composition 50 may be another liquid formulation, a dissolvable capsule, a tablet, a granular material, a powder, and the like that does not readily mix with water and tends to float on top of water.

A preferred oil-based composition is an essential oil. Essential oil has the odor or flavor of the plant from which it comes and is typically used in perfume and flavorings. In alternate embodiments, composition 50 may be another fragrance compound, an air freshener, a deoderizer, an insect repellant, an insecticide, or any other approved chemical additive or agent for enhancing an environment.

Injector 22 is discussed herein for delivering composition 50, such as an essential oil, through a patio misting system to an outdoor patio environment. However, such is not a limitation of the present invention. Injector 22 may be implemented within a variety of environments where misting systems can be used to affect the ambient environment and where the delivery of a particular composition is desired.

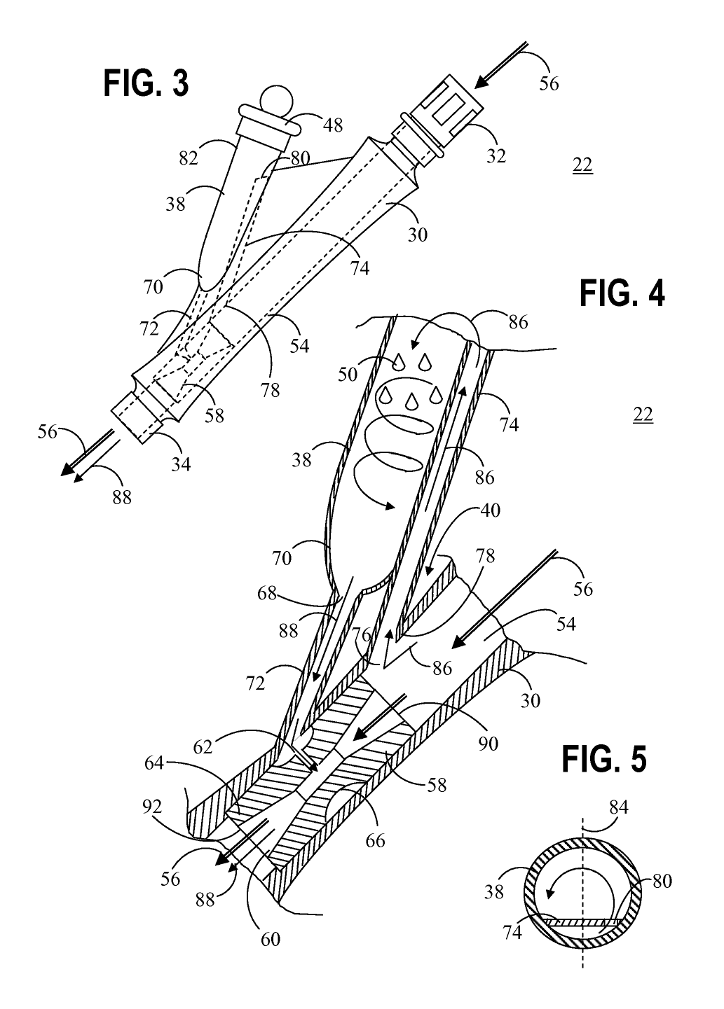

Referring to FIGS. 3-4, FIG. 3 shows a side view of an internal structure of injector 22, and FIG. 4 shows a side sectional view of the internal structure of the injector 22. Main body 30 of injector 22 includes a channel 54 extending from body inlet 32 to body outlet 34. Channel 54 carries a flow of water, represented by an arrow 56, provided from fluid source 36 (FIG. 1) from body inlet 32 to body outlet 34.

A converging-diverging nozzle 58 is positioned within channel 54 proximate body outlet 34. Nozzle 58 includes a passage 60 aligned with channel 54, and a fluid port 62 extending through a side wall 64 of nozzle 58. In one embodiment, fluid port 62 extends through side wall 64 at a throat 66 of converging-diverging nozzle 58.

A chamber outlet 68 is located at a lower end 70 of mixing chamber 38 and is in fluid communication with fluid port 62. More specifically, a tube portion 72 of injector 22 interconnects chamber outlet 68 with fluid port 62.

Injector 22 further includes a conduit 74 having a conduit inlet 76 extending through a side of main body 30 upstream from converging-diverging nozzle 58. In one embodiment, conduit inlet 76 may be positioned proximate a vertex 78 of acute angle 40 formed between lower end 70 of mixing chamber 38 and main body 30. Conduit 74 extends along approximately an entirety of length 42 (FIG. 2) of mixing chamber 38 from conduit inlet 76 to a conduit outlet 80 at an upper end 82 of mixing chamber 38.

FIG. 5 shows a top sectional view of mixing chamber 38 of injector 22. In one embodiment, conduit 74 is formed such that it largely resides inside of mixing chamber 38. Conduit outlet 80 is out of alignment with a radial direction 84. The advantages of the misalignment of conduit outlet 80 relative to radial direction 84 will be discussed below.

Referring back to FIGS. 3-4, water 56 from fluid source 36 (FIG. 1) enters channel 54 of main body 30. A portion of water 56, represented by arrows 86, enters conduit 74 via conduit inlet 76 and is carried by conduit 74 to conduit outlet 80. Portion 86 of water 56 is expelled from conduit outlet 80 into mixing chamber 38. The configuration of main body 30 and conduit inlet 76 provides for a small percentage of water 56 to be diverted into mixing chamber 38. Conduit outlet 80 located at upper end 82 of mixing chamber 38 is particularly advantageous when composition 50 is an oil-based product, such as essential oil, because the oil-based composition typically has a lower specific gravity then water. Thus, essential oil will float on top of any water 56 that may be present in mixing chamber 38.

Entry of portion 86 of water 56 at upper end 82 of mixing chamber will result in its passage through composition 50. In addition, the misalignment of conduit outlet 80 relative to radial direction 84 of mixing chamber 38 causes a tangential delivery of portion 86 of water 56 into mixing chamber 38. This tangential delivery results in swirling, or turbulent, mixing of portion 86 of water 56 with composition 50. This turbulence helps mix composition 50 with portion 86 of water in mixing chamber 38. Meanwhile, chamber outlet 68 is at lower end 70 of mixing chamber 38 so that the liquid exiting mixing chamber 38 is a mixture 88 water 56 and composition 50.

Converging-diverging nozzle 58 is a Venturi type nozzle. It operates under the conditions where a pressure difference exists between a nozzle inlet 90 and a nozzle outlet 92. This pressure difference creates a vacuum inside converging-diverging nozzle 58, which results in the siphoning of mixture 88 from mixing chamber 38 through fluid port 62. Accordingly, as water 56 flows through channel 54 and through passage 60 of nozzle 58, mixture 88 is pulled into nozzle 58 via fluid port 62 and is mixed with water 56 flowing through nozzle 58. The combination of water 56 and mixture 88 that includes composition 50 exits nozzle 58 and is discharged from body outlet 34 into delivery line 24 (FIG. 1). This combination of water 56 and mixture 88 containing composition 50 subsequently exits nozzles 26 (FIG. 1) as mist 28.

The effective mixing of portion 86 of water 56 with composition 50 in mixing chamber 38 and the siphoning effect of converging-diverging nozzle 58 regulates the concentration of composition 50 in mixture 88 that is eventually injected into the main stream of water 56. Thus, highly concentrated amounts of composition 50 are prevented from entering the main stream of water 56. This results in dilution of composition 50, such as essential oil, into the main water stream over time, so as to provide a long lasting effect to be distributed to the area through nozzles 26. Furthermore, the design of injector 22 enables the siphoning effect even with a rate of flow of water 56 as low as, for example, approximately one tenth of a gallon per minute.

In summary, the present invention teaches of an injector for delivery of a composition into an environment. The injector includes a converging-diverging nozzle in line with a main channel of the injector. Some water is diverted from the main channel to a mixing chamber where it is mixed with the desired composition. The mixture of fluid and composition is siphoned from the mixing chamber via the converging-diverging nozzle where it is subsequently discharged at the appropriate concentration through a misting system. The simple design of the injector system enables inexpensive manufacturing. Furthermore, it can readily be placed in-line with a standard hose spigot before the delivery line or filter for a typical patio mist system. A misting system utilizing the injector of the present invention can effectively and uniformly disburse any of a number of oil-based compositions, such as essential oil, fragrance, air freshener, deoderizer, insect repellant, insecticides, or any other approved chemical additive or agent for enhancing any of a wide variety of environments. Furthermore, the composition is suspended or otherwise dissolved into the mist and is therefore less susceptible to removal from the environment by air currents.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A system for introducing a composition into a fluid, said system comprising:
a main body having a body inlet, a body outlet, and a channel for carrying a flow of fluid from said body inlet to said body outlet;
a converging-diverging nozzle positioned within said channel, said nozzle including a passage aligned with said channel, and said nozzle further including a fluid port extending through a side wall of said nozzle;
a mixing chamber for placement of said composition, said mixing chamber having a chamber outlet in fluid communication with said fluid port; and
a conduit having a conduit inlet through a side of said main body upstream from said converging-diverging nozzle and having a conduit outlet into said mixing chamber upstream from said chamber outlet, said conduit carrying a portion of said fluid to said mixing chamber to mix with said composition.

2. A system as claimed in claim 1 wherein a mixture of said composition and said fluid is siphoned from said mixing chamber into said passage of said nozzle via said fluid port and is discharged from said body outlet.

3. A system as claimed in claim 1 wherein said converging-diverging nozzle is located within said channel proximate said body outlet.

4. A system as claimed in claim 1 wherein said fluid port extends through said side wall of said nozzle at a throat of said nozzle.

5. A system as claimed in claim 1 wherein said mixing chamber includes an upper end and a lower end, said conduit outlet is positioned at said upper end of said mixing chamber and said chamber outlet is positioned at said lower end of said mixing chamber.

6. A system as claimed in claim 1 wherein said mixing chamber is arranged with said main body to form an acute angle between a length of said mixing chamber and said main body, said length of said mixing chamber being greater than a width of said mixing chamber.

7. A system as claimed in claim 1 wherein said conduit inlet is positioned proximate a vertex of an acute angle formed between a lower end of said mixing chamber and said main body.

8. A system as claimed in claim 7 wherein said conduit extends along approximately an entirety of a length of said mixing chamber from said conduit inlet to said conduit outlet.

9. A system as claimed in claim 1 wherein said conduit outlet is misaligned with a radial direction of said mixing chamber to deliver said portion of said fluid into said mixing chamber tangentially.

10. A system as claimed in claim 1 wherein said mixing chamber comprises a cap, said cap being removable in order to place said composition in said mixing chamber.

11. A system as claimed in claim 10 further comprising a secondary container interposed between said mixing chamber and said cap for placement of an addition volume of said composition.

12. A system as claimed in claim 1 wherein:
said body inlet is adapted for connection to a fluid source for receiving said fluid; and
said body outlet is adapted for connection to a delivery line for discharge of a mixture of said fluid and said composition.

13. A system as claimed in claim 12 wherein said delivery line is in fluid communication with downstream misting nozzles, and said mixture of said fluid and said composition is discharged from said misting nozzles in response to said flow of said fluid through said converging-diverging nozzle.

14. A system as claimed in claim 1 wherein said composition is an oil-based composition.

15. A system as claimed in claim 1 wherein said composition is an essential oil.

16. A misting system comprising:
an injector, said injector including:
a main body having a body inlet adapted for connection to a fluid source for receiving water, a body outlet, and a channel for carrying a flow of water from said body inlet to said body outlet;
a converging-diverging nozzle positioned within said channel, said nozzle including a passage aligned with said channel, and said nozzle further including a fluid port extending through a side wall of said nozzle;
a mixing chamber for placement of a composition, said mixing chamber having a chamber outlet in fluid communication with said fluid port; and
a conduit having a conduit inlet through a side of said main body upstream from said converging-diverging nozzle and having a conduit outlet into said mixing chamber upstream from said chamber outlet, said conduit carrying a portion of said water to said mixing chamber to mix with said composition, wherein a mixture of said composition and said water is siphoned from said mixing chamber into said passage of said nozzle via said fluid port;
a delivery line connected to said body outlet of said main body, said mixture being discharged from said body outlet into said delivery line; and
misting nozzles in fluid communication with said delivery line, said mixture of said water and said composition being discharged from said misting nozzles in response to said flow of fluid through said converging-diverging nozzle.

17. A misting system as claimed in claim 16 wherein said composition is an essential oil, and said mixing chamber comprises a removable cap, said cap being removed in order to place said essential oil in said mixing chamber.

18. A system for introducing an oil-based composition into a fluid, said system comprising:
a main body having a body inlet, a body outlet, and a channel for carrying a flow of fluid from said body inlet to said body outlet;
a converging-diverging nozzle positioned within said channel, said nozzle including a passage aligned with said channel, and said nozzle further including a fluid port extending through a side wall of said nozzle at a throat of said nozzle;
a mixing chamber for placement of said oil-based composition, said mixing chamber including an upper end, a lower end, and a chamber outlet positioned at said lower end of said mixing chamber, said chamber outlet being in fluid communication with said fluid port; and
a conduit having a conduit inlet through a side of said main body upstream from said converging-diverging nozzle and having a conduit outlet positioned at said upper end of said mixing chamber, said conduit carrying a portion of said fluid to said mixing chamber to mix with said oil-based composition.

19. A system as claimed in claim 18 wherein said conduit outlet is misaligned with a radial direction of said mixing chamber to deliver said portion of said fluid into said mixing chamber tangentially.

20. A system as claimed in claim 18 wherein:
said body inlet is adapted for connection to a fluid source for receiving said fluid; and
said body outlet is adapted for connection to a delivery line for discharge of a mixture of said fluid and said composition.
